(19) United States
(12) Patent Application Publication
(10) Pub. No.: US 2008/0066262 A1
(43) Pub. Date: Mar. 20, 2008

(54) Hinge and foldable electronics device using the hinge

(75) Inventors: Tai-Jun Liu, Shenzhen (CN); Rui-Hao Chen, Shenzhen (CN); Gang Yang, Shenzhen (CN); Shui-Yuan Qin, Shenzhen (CN); Hsiao-Hua Tu, Shindian (TW); Chia-Hua Chen, Shindian (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignees: SHENZHEN FUTAIHONG PRECISION INDUSTRY CO., LTD.; SUTECH TRADING LIMITED

(21) Appl. No.: 11/985,744

(22) Filed: Nov. 16, 2007

Related U.S. Application Data
(63) Continuation of application No. 11/136,787, filed on May 25, 2005.

(51) Int. Cl. E05D 11/10

(52) U.S. Cl. 16/319

(57) ABSTRACT

A foldable electronic device (100) includes a main housing (60) and a cover (80) mounted to the main housing by a hinge (20). The cover is movable between a first position where a side of the main housing is covered by the cover and a second position where the side of the main housing is revealed from the cover. The hinge includes an axle (22), a block (26) retained on the axle with threading engagement therebetween, and an elastic member (24) retained between the axle and the block. When the block is moved to guide the cover to the first position, the elastic member is compressed. When the block is released, the block automatically moves due to decompression of the elastic member to drive the cover to the second position.

### CROSS-REFERENCE TO RELATED APPLICATIONS

This application is a continuation application of U.S. patent application Ser. No. 11/136,787, entitled “HINGE AND FOLDABLE ELECTRONIC DEVICE USING THE HINGE” and filed on May 25, 2005, and is related to U.S. patent application Ser. No. 11/012,945, entitled “HINGE ASSEMBLY” and filed on Dec. 14, 2004. The disclosure of the above identified applications are incorporated herein by reference.

### BACKGROUND OF THE INVENTION

1. Field of the Invention

The present invention generally relates to a hinge for connecting two housings of a foldable electronic device such as a foldable mobile phone, and particularly to a hinge which facilitates opening and closing of the device.

2. Discussion of the Related Art

With the development of the technologies of wireless communication and information processing, portable electronic devices such as foldable mobile phones are now in widespread use. These electronic devices enable consumers to enjoy the convenience of high-tech services almost anytime and anywhere. Foldable electronic devices are particularly favored by consumers for its convenience.

Foldable electronic devices generally have two housings joined by a type of hinge that allows the main housings to fold upon one another. Usually, electronic components of such foldable electronic device are mainly provided in the main housing, and a few electronic components in the other housing. Other such foldable electronic devices have all the electronic components in the main housing, with the cover only employed for covering a keypad and/or a display of the main housing. Manufacturers are constantly seeking to reduce the volume, size and weight of these foldable electronic devices. Thus, it is desirable that the hinge coupling the main housing with the cover is modularized and miniaturized. A common modularized hinge device has moving parts such as a cam member, a cam follower and a spring held together in a unified structure. The structure is easily and quickly attached to the main housing and the cover during mass production. The purpose of a miniaturized hinge device is to have as a few parts as possible, with the parts being as small as practicable.

Referring first to FIG. 4, U.S. Pat. No. 6,321,415 B1 describes a hinge 10 used to connect a main housing and a cover of a foldable mobile phone. The hinge 10 comprises a shaft 12 having a washer fixed on a first end thereof, a spring 14, a cam 16, and a follower 18. The spring 14, the cam 16 and the follower 18 are all axially mounted one by one around the shaft 12. One end of the spring 14 is fixed to the cam 16. A long, axial knob 161 is formed on an outside of the cam 16, for fixing the cam 16 to the main housing. The follower 18 surrounds an opposite second end of the shaft 12. A mounting cavity (not shown) is defined in the mobile phone, for mounting of the hinge 10 therein. A first hole (not shown) is also defined in the mobile phone at a first end of the cavity, so that the first end of the shaft 12 protrudes out of the first hole. A second hole (not shown) is defined in the mobile phone at an opposite second end of the cavity, so that the follower 18 is fixed in the cover and protrudes out from the second hole.

When the main housing and the cover of the mobile phone are in an open state, the spring 14 has an original length without being compressed or stretched, and an end surface of the cam 16 and an end surface of the follower 18 cooperate with each other compactly. When the cover is rotated toward a closed state of the mobile phone, the follower 18 drives the cam 16 to rotate. The spring 14 is twisted and acquires elastic potential energy, and the cover is locked at the closed state by a flip-latch. When the cover is unlocked, it automatically rotates back to the open state by reason of the spring 14 releasing its potential energy.

However, the cam 16 cannot engage steadily with the follower 18. In addition, when the cover is opened, the spring 14 is liable to drive the cover to impact the main housing. The impact may damage the cover, the main housing, or the hinge 10. Furthermore, the hinge 10 is complex and difficult to assemble.

What is needed, therefore, is a simple, stable hinge mechanism which can be operated steadily and safely.

### SUMMARY

In one aspect thereof, a hinge is used for joining a main housing and a cover together of a foldable electronic device. The cover is movable between a first position where a side of the main housing is covered by the cover and a second position where the side of the main housing is revealed from the cover. The hinge includes an axle with a screw thread thereon, a block with a screw hole therein, and an elastic member around the axle. The block is retained on the axle with engagement of the screw thread in the screw hole. The elastic member is retained between the axle and the block. When the block is moved along the axle and undergoes displacement in a first axial direction so as to guide the cover to the first position, the elastic member is compressed. When the block is released, the block automatically moves along the axle and undergoes displacement in a second axial direction opposite to the first axial direction due to decompression of the elastic member so as to drive the cover to the second position.

On another aspect thereof, a foldable electronic device includes a main housing, a cover, and a hinge mechanism interconnecting the main housing with the cover. The cover is disposed next to the main housing so as to be rotatably movable relative to the main housing between a first position where a side of the main housing is covered by the cover, and a second position where the side of the main housing is revealed from the cover. The hinge mechanism includes an axle having a screw thread formed thereon, a block defining a screw hole therein, and an elastic member located around the axle. The axle is engagably movable together with one of the main housing and the cover. The block is engagably movable together with the other of the main housing and the cover. The block is retained on the axle with engagement of the screw thread in the screw hole. The elastic member is retained between the axle and the block. When the block is moved along the axle and undergoes displacement in a first axial direction so as to guide the cover to the first position, the elastic member is compressed. When the block is released, the block automatically moves along the axle and undergoes displacement in a second axial direction opposite to the first axial direction due to decompression of the elastic member so as to drive the cover to the second position.

The structure of the hinge is stable, by reason of the connection provided by the axle between the clip and the block. The mobile phone using the hinge can reduce or eliminate damaging impact that would occur when the cover is opened up from the main housing and reaches an open state.

Other advantages and novel features of the embodiments will become more apparent from the following detailed description thereof when taken in conjunction with the accompanying drawings.

### BRIEF DESCRIPTION OF THE DRAWINGS

Many aspects of the present hinge can be better understood with reference to the following drawings. The components in the drawings are not necessarily to scale, the emphasis instead being placed upon clearly illustrating the principles of the present hinge and its potential applications. Moreover, in the drawings, like reference numerals designate corresponding parts throughout the several views.

FIG. 1 is a schematic view of a foldable electronic device according to a present embodiment;

FIG. 2 is an isometric view of a hinge of the present invention, showing the hinge positioned corresponding to a closed position of the foldable electronic device;

FIG. 3 is an exploded view of the hinge shown in FIG. 2; and

FIG. 4 is an isometric view of a conventional hinge.

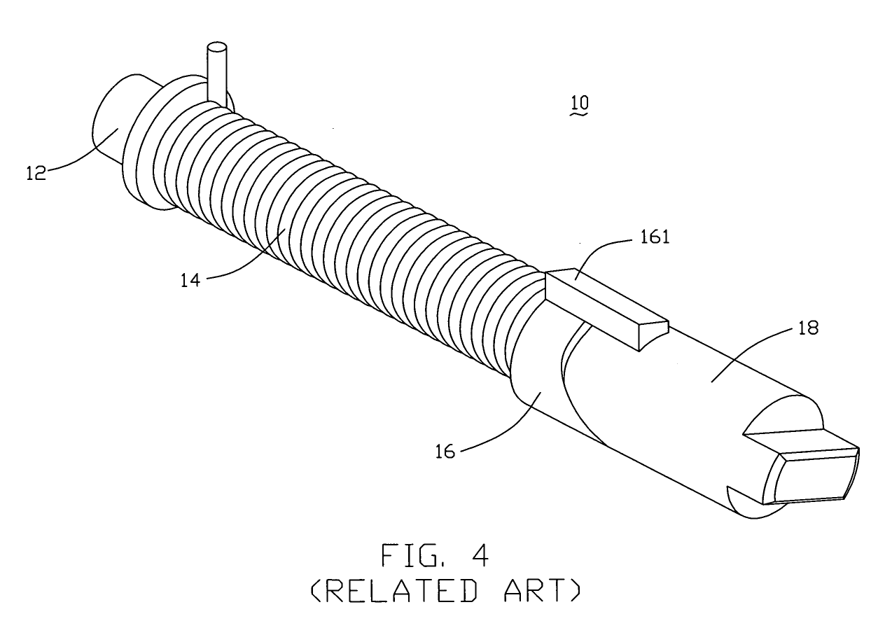

### DETAILED DESCRIPTION OF THE EMBODIMENT

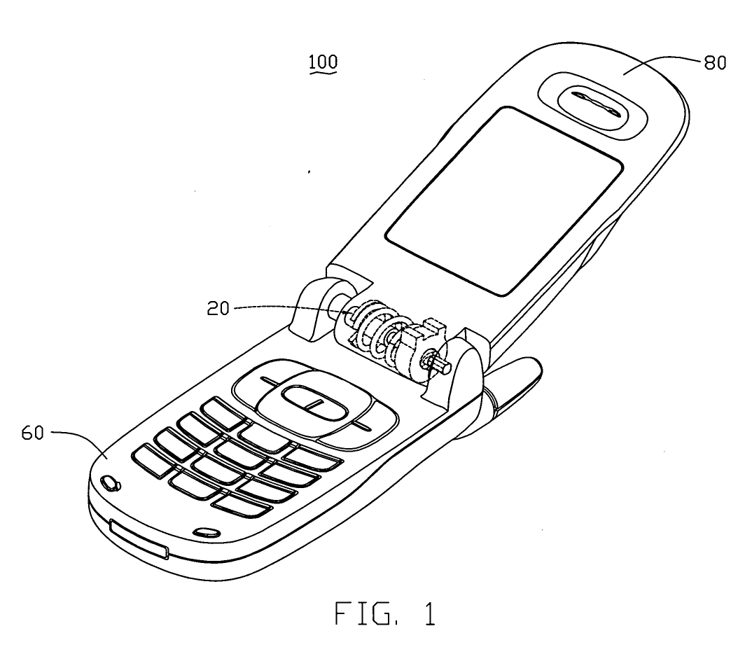

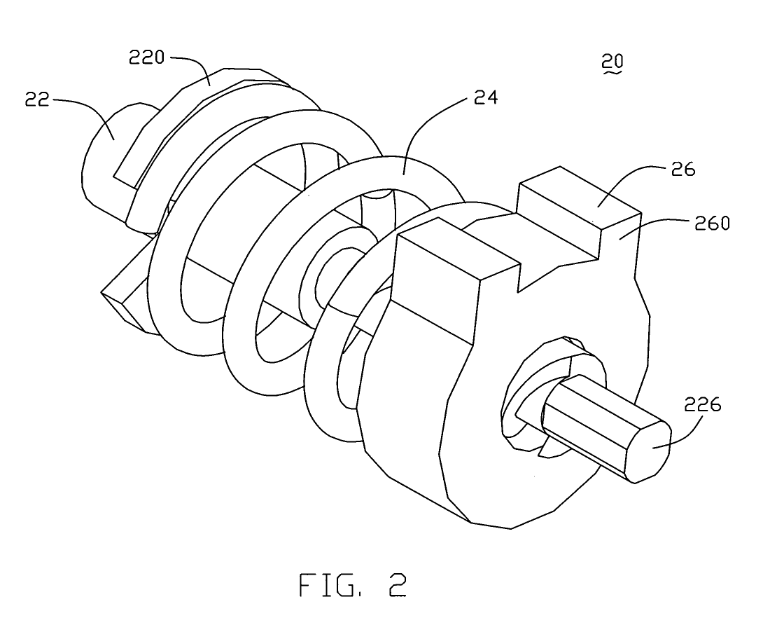

Referring now to the drawings in detail, FIGS. 1-2 show a hinge 20 of a hinge mechanism for joining a cover 80 to a main housing 60 together of a foldable electronic device such as a foldable mobile phone 100. The cover 80 is rotatably movable relative to the main housing 60 between a closed state where a side having a keypad of the main housing 60 is covered by the cover 80, and an open state where the side of the main housing 60 is revealed from the cover 80. The hinge 20 includes a central part like an axle 22 extending along a central axis of the hinge 20, a clip 220, a spring 24, and a peripheral part like a block 26. The clip 220, the spring 24, and the block 26 are mounted to the axle 22 in the order written.

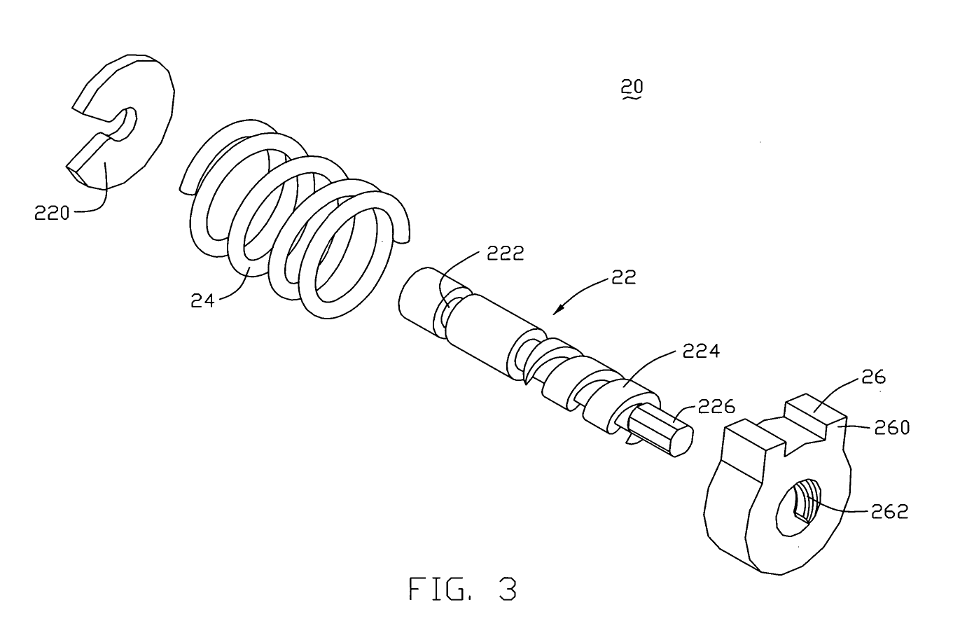

Referring also to FIG. 3, the axle 22 has a first end defining a round groove 222 therein, an opposite second end with a polygonal shaft 226 formed thereon, and an intermediate part with a screw thread 224 formed thereon. The clip 220 is C-shaped, and is configured (i.e., structured and arranged) for being fixed in the round groove 222. The spring 24 is retained between the clip 220 and the block 26. The block 26 has two parallel knobs 260 formed on a circumferential wall thereof and a screw hole 262 defined through a center thereof. The screw hole 262 is configured for threadingly receiving the screw thread 224 thereby mounting the block 26 on the axle 22. This helps to ensure that the block 26 does not accidentally detach from the axle 22.

When the hinge 20 is used in the mobile phone 100, the axle 22 and the block 26 can be respectively received in the cover 80 or the main housing 60 of the mobile phone 100. The following detailed description of movement of the hinge 20 assumes that the axle 22 is received in the cover 80, and the block 26 is received in the main housing 60.

The spring 24 stays with its original length when the cover 80 and the main housing 60 of the mobile phone 100 are in the open state. The polygonal shaft 226 of the axle 22 is received in the cover 80, and the knobs 260 of the block 26 are received in the main housing 60. When the cover 80 is rotated down toward the main housing 60, the axle 22 rotates clockwise relative to the block 26 (as viewed in FIG. 3). Due to the engagement of the screw thread 224 in the screw hole 262, the axle 22 draws the clip 220 toward the block 26. The distance between the block 26 and the clip 220 decreases, and the spring 24 is compressed. When the cover 80 reaches the closed state, it is locked thereat by a lock component (not shown) of the main housing 60. At this position, the compressed spring 24 retains a certain amount of elastic potential energy. When the lock component is unlocked, the compressed spring 24 immediately decompresses and releases its potential energy, and the cover 80 automatically rotates to the fully open state.

In the process of opening the cover 80, due to the engagement of the screw thread 224 received in the screw hole 262 of the block 26, the decompression of the compressed spring 24 is slowed down. This helps prevent the cover 80 from impacting the main housing 60 when the cover 80 reaches the open state. In addition, the hinge 10 is steady and reliable, because the axle 22 is mounted substantially between the clip 220 and the block 26. Furthermore, the hinge 10 has relatively a few components, making it simple and easy to manufacture.

In an alternative embodiment, opposite ends of the spring 24 can be formed such that they are fixed to the clip 220 and the block 26 respectively. The clip 220 may be rotatably mounted in the round groove 222. With this configuration, if the cover opens too far relative to the main housing, the distance between the clip 220 and the block 26 increases too much, and the spring 24 is overstretched. Thus, the spring 24 rebounds and draws the clip 220 back toward the block 26. That is, the spring 24 corrects the overstretching, and helps bring the cover to the appropriate position at the open state.

In another alternative embodiment, the clip 220 is fixed in the round groove 222. The spring 24 has a first end fixed to the clip 220 and an opposite second end fixed to the block 26. In a further alternative embodiment, the clip 220 can be omitted, and the first end of the spring 24 can be fixed directly to the first end of the axle 22, with the second end of the spring 24 being fixed to the block 26. With either of these configurations, the spring 24 can acquire more potential energy when the cover 80 is rotated down to the closed state. Furthermore, the spring 24 can be replaced by another kind of suitable elastic member such as a resilient cylinder.

It is to be understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A hinge for a foldable electronic device, the foldable electronic device including a main housing and a cover rotatably mounted to the main housing by the hinge, the cover being movable between a first position where a side of the main housing is covered by the cover and a second position where the side of the main housing is revealed from the cover, the hinge comprising:
an axle with a screw thread formed thereon;
a block with a screw hole defined therein; and
an elastic member located around the axle;
wherein the block is retained on the axle with engagement of the screw thread in the screw hole, and the elastic member is retained between the axle and the block in such a manner that when the block is moved along the axle and undergoes displacement in a first axial direction so as to guide the cover to the first position, the elastic member is compressed, and when the block is released, the block automatically moves along the axle and undergoes displacement in a second axial direction opposite to the first axial direction due to decompression of the elastic member so as to drive the cover to the second position.

2. The hinge as claimed in claim 1, wherein the elastic member is a spring.

3. The hinge as claimed in claim 1, wherein the axle defines a groove in one end thereof, the groove being configured for receiving a C-shaped clip therein.

4. The hinge as claimed in claim 3, wherein one end of the elastic member is fixed to the clip, and another end of the elastic member is fixed to the block.

5. The hinge as claimed in claim 1, wherein the axle is configured for rotating with one of the cover and the main housing and the block being configured for ratating with the other of the cover and the main housing.

6. The hinge as claimed in claim 5, wherein the axle defines a polygonal shaft on one end thereof, the polygonal shaft being configured for engaging with one of the cover and the main housing.

7. The hinge as claimed in claim 5, wherein the block has two knobs formed on an outside thereof, the two knobs being configured for engaging with the other of the cover and the main housing.

8. A hinge for a foldable electronic device, the foldable electronic device including a main housing enclosing parts of the foldable electronic device and a cover enclosing other parts of the foldable electronic device and disposed next to the main housing so as to be rotatably movable relative to the main housing between a first position where a side of the main housing is covered by the cover, and a second position where the side of the main housing is revealed from the cover, the hinge comprising:
a central part being engagably movable together with one of the main housing and the cover;
a peripheral part being engagably movable together with the other of the main housing and the cover, the peripheral part being formed surrounding the central part and movably engagable with the central part; and
an elastic member which comprises one end abutting the central part and another end abutting the peripheral part, wherein when the peripheral part is moved to compress the elastic member, engagement of the peripheral part and the central part enables rotational movement and axial movement of the peripheral part along the central part so as to guide the movement of the cover to the first position, and when the peripheral part is released, the peripheral part automatically moves to drive the cover to the second position due to decompression of the elastic member.

9. The hinge as claimed in claim 8, wherein the central part is an axle extending along interconnection portions of the main housing and the cover.

10. The hinge as claimed in claim 9, wherein the peripheral part is a block with the axle extending therethrough.

11. The hinge as claimed in claim 10, wherein the engagement of the central part and the peripheral part is performed by screw threads formed on the central part and a screw hole formed in the peripheral part.

12. A foldable electronic device comprising:
a main housing;
a cover disposed next to the main housing so as to be rotatably movable relative to the main housing between a first position where a side of the main housing is covered by the cover, and a second position where the side of the main housing is revealed from the cover; and
a hinge mechanism interconnecting the main housing to the cover so as to allow movement of the cover relative to the main housing between the first position and the second position, the hinge mechanism comprising:
an axle being engagably movable together with one of the main housing and the cover, the axle having a screw thread formed thereon;
a block being engagably movable together with the other of the main housing and the cover, the block defining a screw hole therein, the block being retained on the axle with engagement of the screw thread in the screw hole; and
an elastic member located around the axle;
wherein the elastic member is retained between the axle and the block in such a manner that when the block is moved along the axle and undergoes displacement in a first axial direction so as to guide the cover to the first position, the elastic member is compressed, and when the block is released, the block automatically moves along the axle and undergoes displacement in a second axial direction opposite to the first axial direction due to decompression of the elastic member so as to drive the cover to the second position.

13. The foldable electronic device as claimed in claim 12, wherein the elastic member is a spring.

14. The foldable electronic device as claimed in claim 12, wherein the axle defines a groove in one end thereof, the groove being configured for receiving a C-shaped clip therein.

15. The foldable electronic device as claimed in claim 14, wherein one end of the elastic member is fixed to the clip, and another end of the elastic member is fixed to the block.

16. The foldable electronic device as claimed in claim 12, wherein the axle defines a polygonal shaft on one end thereof, the polygonal shaft being configured for engaging with one of the cover and the main housing.

17. The foldable electronic device as claimed in claim 12, wherein the block has two knobs formed on an outside thereof, the two knobs being configured for engaging with the other of the cover and the main housing.
